(19) United States
(12) Patent Application Publication
(10) Pub. No.: US 2009/0250572 A1
(43) Pub. Date: Oct. 8, 2009

(54) COLLAPSIBLE FRAME

(76) Inventor: Jui-Pin CHENG, Taichung Hsien (TW)

Correspondence Address: Hershkovitz & Associates, LLC, 2845 Duke Street, Alexandria, VA, 22314, US

(21) Appl. No.: 12/062,039

(22) Filed: Apr. 3, 2008

(51) Int. Cl. F16M 11/38

(52) U.S. Cl. 248/188.6

(57) ABSTRACT

A collapsible frame has four posts and at least two trays separately mounted on the posts. Each tray is composed of two longitudinal brackets, two transverse brackets, four connectors and multiple slabs. The brackets are mounted together to form a rectangular tray frame with the connectors, and the multiple slabs are mounted on the tray frame. Because the tray can be disassembled and reassembled, the collapsible frame could be packed in a small package. Therefore, the collapsible frame is convenient in packing and transportation.

### BACKGROUND OF THE INVENTION

1. Field of Invention

The present invention relates to a frame, and more particularly to a collapsible frame that could be disassembled and packed in a small volume.

2. Description of the Related Art

A conventional collapsible frame could be used for storing or displaying goods. With reference to FIGS. 7 and 8, the conventional collapsible frame (80) has at least two trays (81) and four posts (82). Each tray (81) has four corners and four loops (83). Each loop (83) is mounted at one of the corners. The posts (82) are correspondingly mounted through the loops (83). For fixing the posts (82), four fasteners (84) are used for firmly holding the posts (82). Each fastener (84) has a male holder (841) and a female holder (842). The male holder (841) is connected with the female holder (842) to form a circular fastener (84) and is mounted through by a corresponding post (82).

Before the collapsible frame (80) is expanded, the trays (81), the posts (82) and the fasteners (84) are packed as a large flat package. Therefore, to store the package needs a lot of space and is troublesome, and this is inconvenient for transportation because the trays (81) could not be dismantled.

Thus, a real need exists for a collapsible frame that is convenient for storage and transportation.

### SUMMARY OF THE INVENTION

The primary objective of the present invention is to provide a collapsible frame that could be packed in a small volume.

A collapsible frame of the present invention has four posts and at least two trays separately mounted on the posts. Each tray is composed of two longitudinal brackets, two transverse brackets, four connectors and multiple slabs. The brackets are mounted together to form a rectangular tray frame with the connectors, and the multiple slabs are respectively mounted on the tray frame. Because the tray can be disassembled and reassembled, the collapsible frame is collapsible and can be packed in a small package. Therefore, the collapsible frame is convenient in packing and transportation.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible frame in accordance with the present invention;

FIG. 2 is an enlarged exploded perspective view of the collapsible frame in FIG. 1;

FIG. 3 is a perspective view of a tray of the collapsible frame in FIG. 1;

FIG. 4 is a partial perspective view of the tray of the collapsible frame in FIG. 1;

FIG. 5 is a partial perspective view of the tray in FIG. 4 with a post inserting there into;

FIG. 6 is an exploded perspective view of the collapsible frame in FIG. 1 before assembling;

FIG. 7 is a perspective view of a conventional collapsible frame in accordance with the prior art; and

FIG. 8 is an enlarged exploded perspective view of the conventional collapsible frame in FIG. 7.

### DETAILED DESCRIPTION OF THE INVENTION

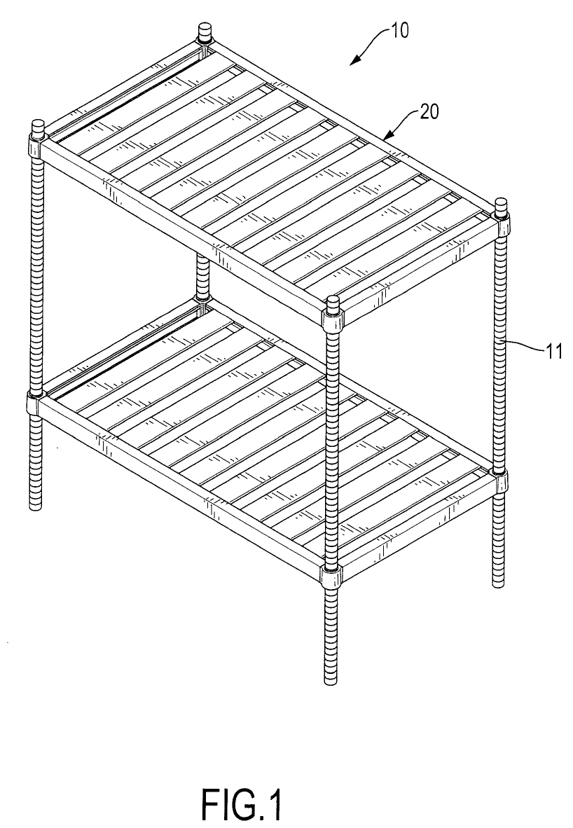

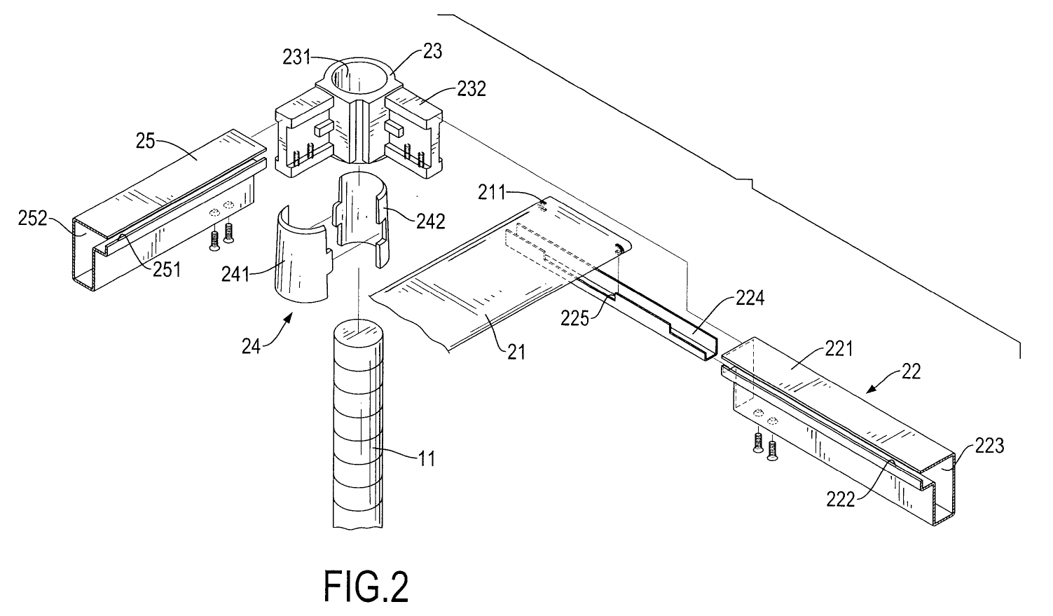

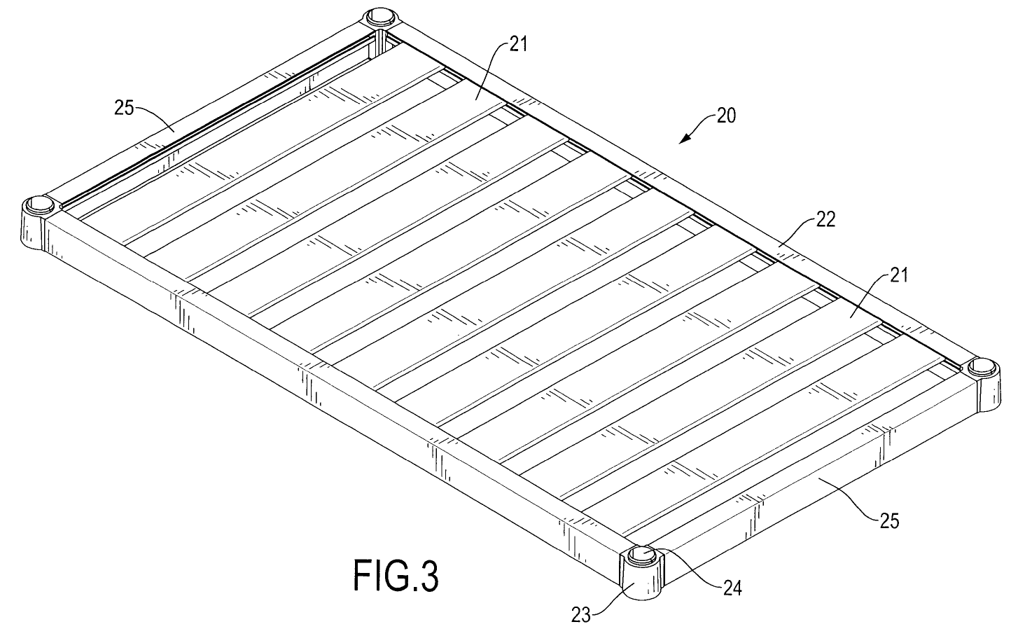

With reference to FIGS. 1 to 3, a collapsible frame (10) in accordance with the present invention has at least two trays (20) and four posts (11). The trays (20) are separately mounted on the posts (11). Each tray (20) has multiple slabs (21), two longitudinal brackets (22), four connectors (23), four fasteners (24) and two transverse brackets (25). The longitudinal brackets (22) and the transverse brackets (25) are connected together by the connectors (23) to form a rectangular tray frame. Therefore, the two longitudinal brackets (22) are parallel with each other and the two transverse brackets (25) are parallel with each other. The multiple slabs (21) are separately mounted on the rectangular tray frame to form a tray. The posts (11) are respectively mounted through the connectors (23) of the trays (20).

Each slab (21) has two ends, two longitudinal edges and four notches (211). Two notches (211) are respectively defined in the longitudinal edges at one of the ends, and the other two notches (211) are respectively defined in the longitudinal edges at the other end.

Each longitudinal bracket (22) has a bracket body (221) and a holder (224). The bracket body (221) has an inner surface, a top surface, a channel (222) and a receiving cavity (223). The channel (222) is defined in the inner surface of the bracket body (221) near the top surface. The receiving cavity (223) is longitudinal defined through the longitudinal bracket (22) and communicates with the channel (222). The holder (224) is mounted inside the receiving cavity (223) in the bracket body (221). The holder (224) is U-shaped in cross section and has an inner surface and multiple recesses (225). The recesses (225) are separately defined in the inner surface for holding the slabs (21). The ends of the slabs (21) are respectively mounted inside the recesses (255) in the holders (24), and the notches (211) defined in the slabs (21) engage the inner surfaces of the holders (24). After the multiple slabs (21) are mounted on the two holders (224) of the longitudinal brackets (22), the multiple slabs (21) and the holders (224) are slid into the bracket bodies (221) via the channels (222). Therefore, the multiple slabs (21) will extend from the channels (222) in the longitudinal brackets (22).

Each transverse bracket (25) has an inner surface, a top surface, a channel (251) and a receiving cavity (252). The channel (251) is defined in the inner surface of the bracket body (25) near the top surface. The receiving cavity (252) is longitudinal defined through the transverse bracket (25) and communicates with the channel (251).

Each connector (23) has a circular receiver (231) and two wings (232). The circular receiver (231) has an outer surface. The two wings (232) are respectively formed on the outer surface of the circular receiver (231). The included angle between of the two wings (232) are about 90 degree. One of the wings (232) of the connector (23) is extended into the receiving cavity (223, 252) of a corresponding one of the longitudinal brackets (22) and transverse brackets (25), and the connectors (23) and the brackets (22, 25) are further fixed by screws.

The fasteners (24) are received respectively in the connectors (23). Each fastener (24) has a male holder (241) and a female holder (242). The male holder (241) is connected with the female holder (242) to form a circular fastener (24) for securely holding a corresponding post (11) with the corresponding tray (20).

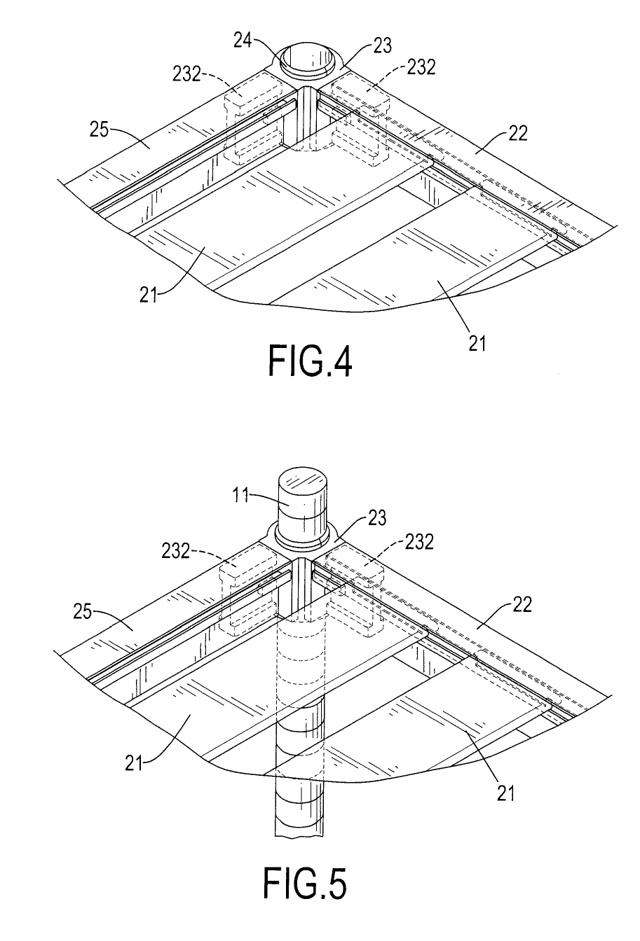

With reference to FIGS. 4 and 5, after the connectors (23) are connected with the brackets (22, 25), the posts (11) are mounted through the fasteners (24) for assembling the trays (10).

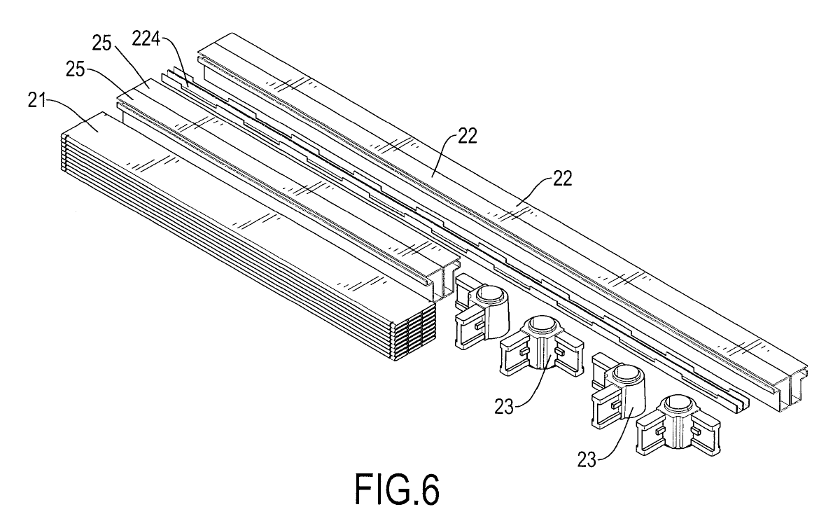

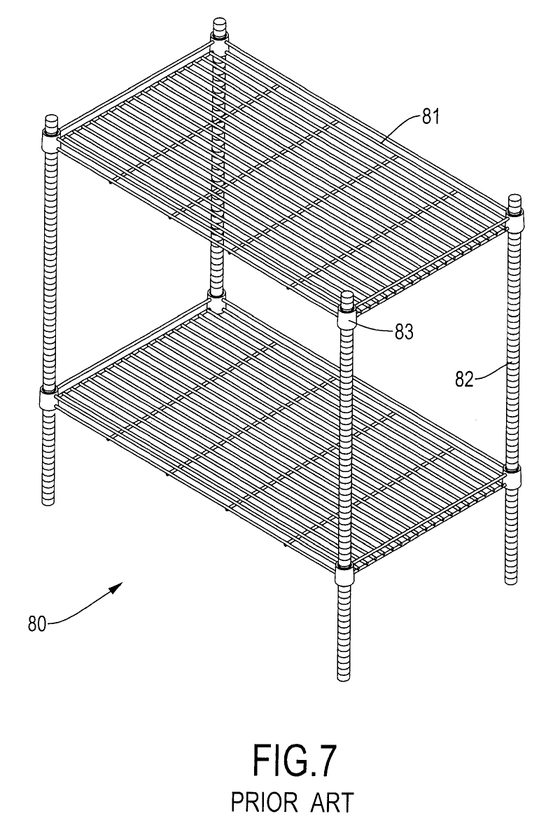

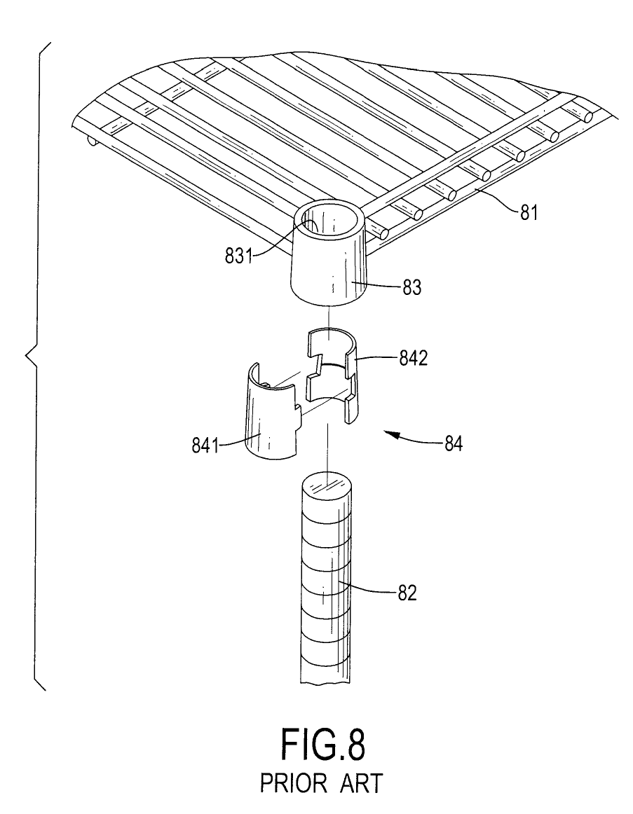

With reference to FIG. 6, before the collapsible frame (10) is assembled, all elements, including the brackets (22, 25), the multiple slabs (21), the connectors (23) and the fasteners (24), could be taken apart for package. Accordingly, the package volume for the collapsible frame (10) can be reduced to increase the convenience of storage and transportation.

The advantages of the collapsible frame in accordance with the present invention are as follows.

1. The package space for the collapsible frame is small, and this is convenient for transportation.

2. To assemble the collapsible frame is easy, and the frame is suitable for being a DIY furniture.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An collapsible frame comprising
four posts;
at least two trays separately mounted on the four posts, each tray having
two longitudinal brackets, each longitudinal bracket having
a bracket body having
an inner surface;
a top surface;
a channel defined in the inner surface of the bracket body near the top surface; and
a receiving cavity longitudinal defined through the longitudinal bracket and communicating with the channel; and
a holder mounted inside the receiving cavity in the bracket body having
an inner surface; and
multiple recesses separately defined in the inner surface;
two transverse brackets respectively connected to the two longitudinal brackets for forming a rectangular tray frame, each transverse bracket having
an inner surface;
a top surface; and
a receiving cavity longitudinal defined through the transverse bracket;
four connectors, each connector mounted between one of the longitudinal brackets and an adjacent one of the transverse brackets and having
a circular receiver having an outer surface; and
two wings respectively formed on the outer surface of the circular receiver and extending into the receiving cavity of a corresponding one of the longitudinal brackets and transverse brackets for connecting adjacent transverse bracket and longitudinal bracket together;
multiple slabs, each slab mounted between the channels of the two longitudinal brackets and having
two ends;
two longitudinal edges; and
four notches, two of the notches respectively defined in the two longitudinal edges at one of the ends, and the other two of the notches respectively defined in the two longitudinal edges at the other end, each notch engaging the inner surface of a corresponding one of the holders.

2. The collapsible frame as claimed in claim 1, wherein the collapsible frame further comprises four fasteners, each fasten is received in one of the connectors and has
a male holder and
a female holder connected with the male holder to form a circular fastener for securely holding a corresponding one of the posts with a corresponding tray.

3. The collapsible frame as claimed in claim 2, wherein each transverse bracket further comprises a channel defined in the inner surface of the bracket body near the top surface and communicating with the receiving cavity in the transverse bracket.

4. The collapsible frame as claimed in claim 1, wherein an included angle is defined between the two wings of each connector and is 90 degree.
